(19) United States
(12) Patent Application Publication
(10) Pub. No.: US 2006/0124534 A1
(43) Pub. Date: Jun. 15, 2006

(54) Automatic transmission easy change fluid replacement system

(76) Inventor: Cesar Cortes Galvez, Richmond, CA (US)

Correspondence Address: Cesar Cortes Galvez, P.O. Box 70423, Richmond, CA, 94807, US

(21) Appl. No.: 10/919,809

(22) Filed: Dec. 15, 2004

(51) Int. Cl. B01D 35/28

(52) U.S. Cl. 210/443; 210/444; 210/171

(57) ABSTRACT

The A.T.E.C. is introducing an easy way to change the fluid in a vehicles transmission, and at a much lower price for the consumer. With current transmissions, when changing the fluid, the consumer has to remove the whole pan, many bolts, remove the oily used filter, clean the pan and the magnet, then do the whole process in reverse to pour in the new fluid. All this uses a lot of time, just to change the fluid. All the time and energy it takes to change the fluid makes it very costly and time consuming to change the fluid the consumer or by a professional.

### CROSS-REFERENCE TO RELATED APPLICATIONS

This invention relates to U.S. Pat. No. 6,585,889, due to the fact that it deals with the transmission oil pan with a drain plug.

### STATEMENT REGARDING FEDERALLY SPONSORED RESEARCH OR DEVEL.

N/A

### REFERENCE TO SEQUENCE LISTING, A TABLE, OR A COMPUTER PROGRAM LISTING COMPACT DISC APPENDIX

N/A

### BACKGROUND OF THE INVENTION

This invention pertains to vehicle transmissions. It also pertains to the following patent classifications, Class 184 sub-class 6.24 & 6.25, Class 210, Class 220, and Class 296.

### BREIF SUMMARY OF INVENTION

The A.T.E.C. introduces a new easy way to change the fluid in a transmission. By placing the filter outside the oil pan, the owner can change the filter and the fluid without opening the transmission, which saves time and money. The A.T.E.C. will also decrease the chances for debris to enter the transmission and cause damage. This invention will also increase the lifetime of the transmission by cooling the fluid, and trapping all the debris outside the transmission.

### DRAWINGS

FIG. 1: Frontal view of the transmission oil pan with the filter one the side, and the return line sticking up from inside.

FIG. 2: Side view of oil pan with the filter on the side and the return line sticking up from the inside.

FIG. 3: A view from behind that shows the oil filter on the side. The return line sticking up from the inside, and the drain plug is located anywhere on the oil pan that is convenient, on the side of the oil pan.

FIG. 4: A view from the top of the oil pan looking down. It shows the filter, the return line, and the drain plug.

FIG. 5: A bottom view of the oil pan with the filter and the cooling bars on the oil pan.

FIG. 6: A view looking at the inner workings of the filter and return line from the outside. Showing the inlet line for the oil on the bottom where the oil filters through the filter and is then sucked up the return line, located above the inlet line.

FIG. 7: An inside view showing the inlet line below, and the return line above.

FIG. 8: A top view showing how the head of the filter the is welded onto the oil pan (turned on its side for viewing purposes), with the inner workings of the filter, and the drain plug.

FIG. 8A: The magnet that fits snugly around the bottom section of the filter, and can be removed and placed on the new filter at the time of the oil change.

FIG. 9: A top view of the oil pan that shows the inlet line and return line to show how it meets up with the head in which the filter is attached. The head is permanently installed on the oil pan. It also shows the inner workings of the return line.

FIG. 9A: The head of the filter is permanently attached to the oil pan. On the bottom is where the inlet line up and has an opening into the filter head where a slit in the head allows the oil into the filter (like an engine's filter).

FIG. 9B: A measuring stick that will assure that the return line has been properly placed into the transmission when installing the new oil pan.

FIG. 9C: A spacer to place on the transmission oil pan when installing the new system to an older vehicle. This spacer will take the place of one of the bolts for the oil pan when sealing the oil pan to the transmission. This spacer is not necessary in all vehicles, only when there is not enough clearance with the filter and head between the transmission and the body of the vehicle when installing the new oil pan.

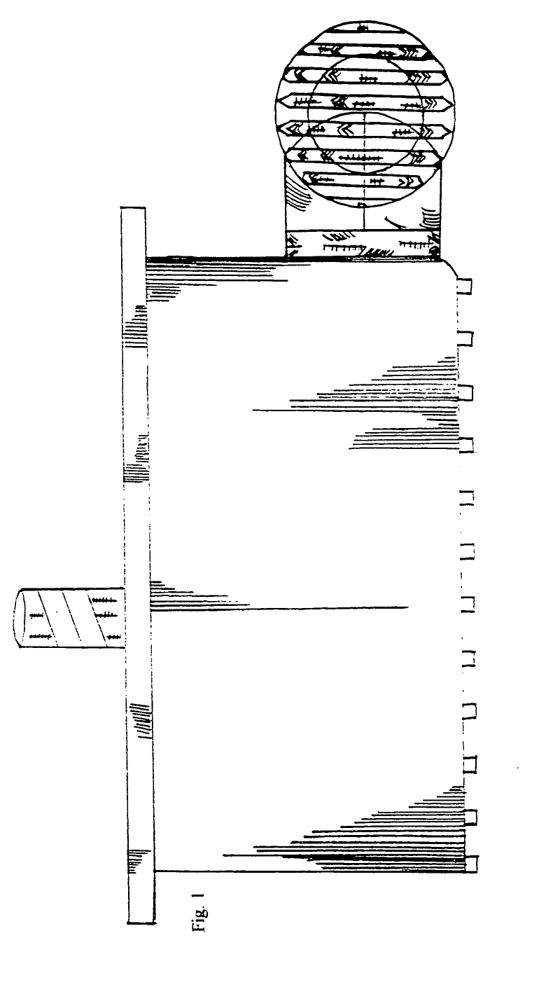

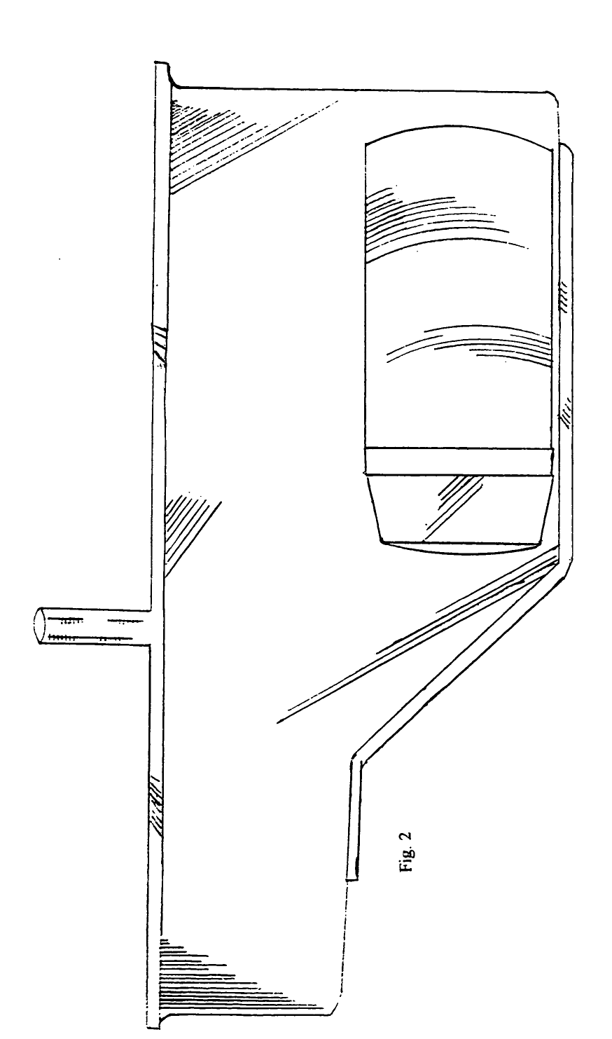

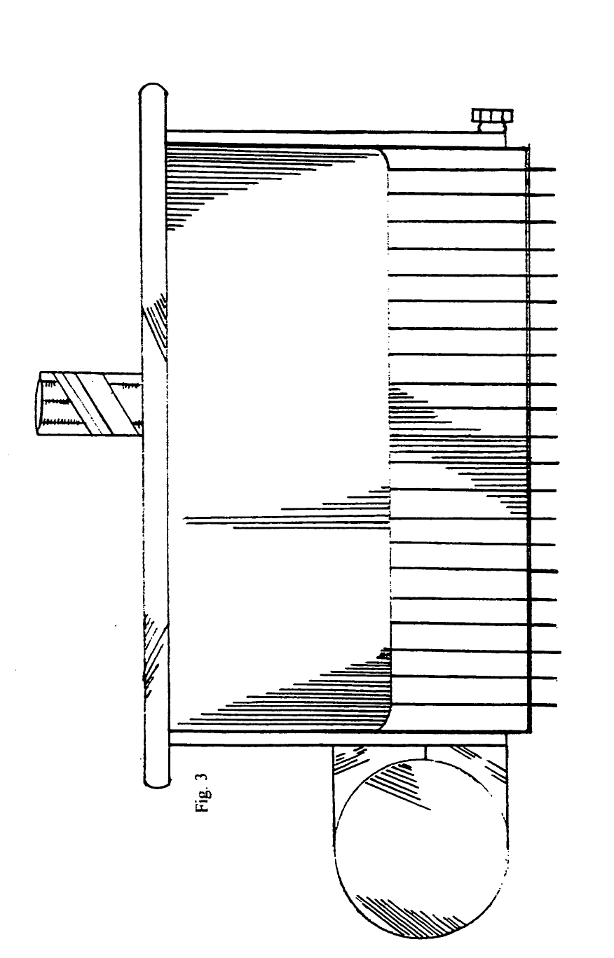

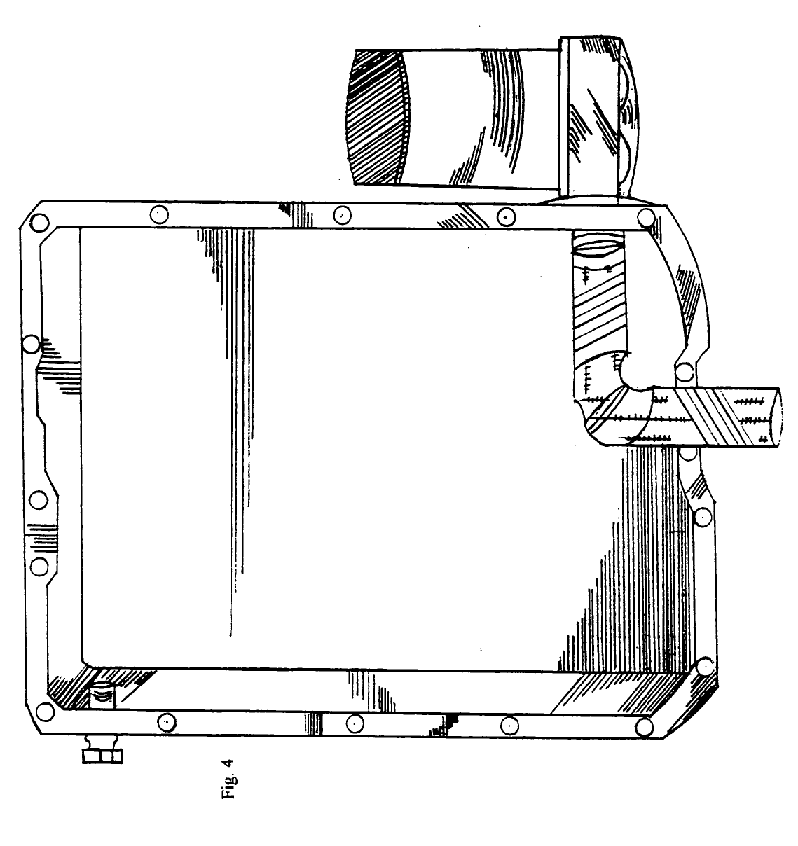

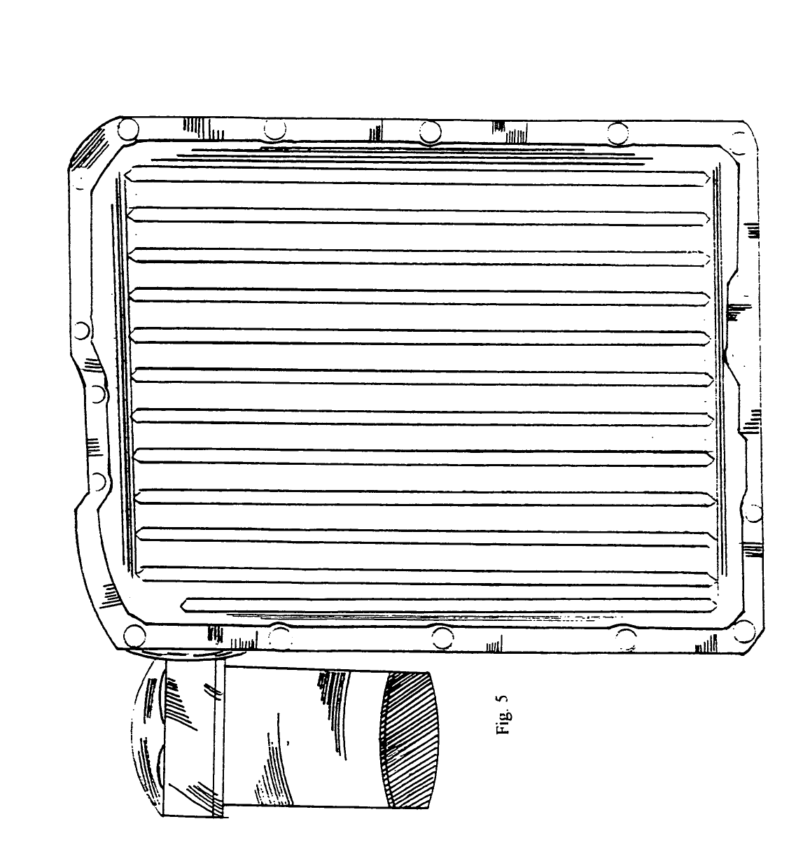

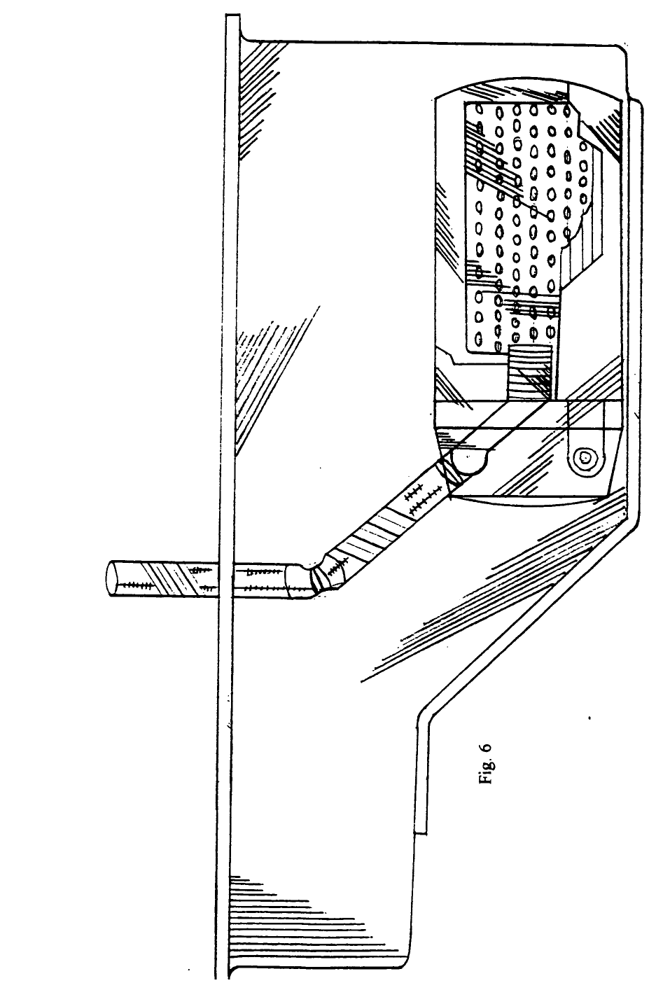

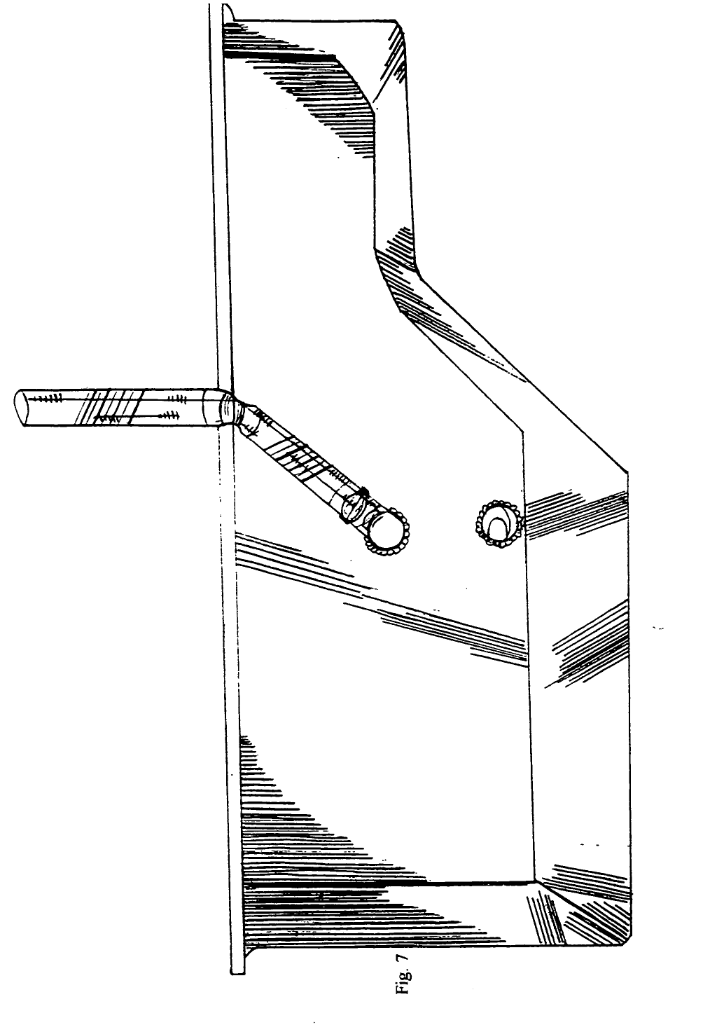

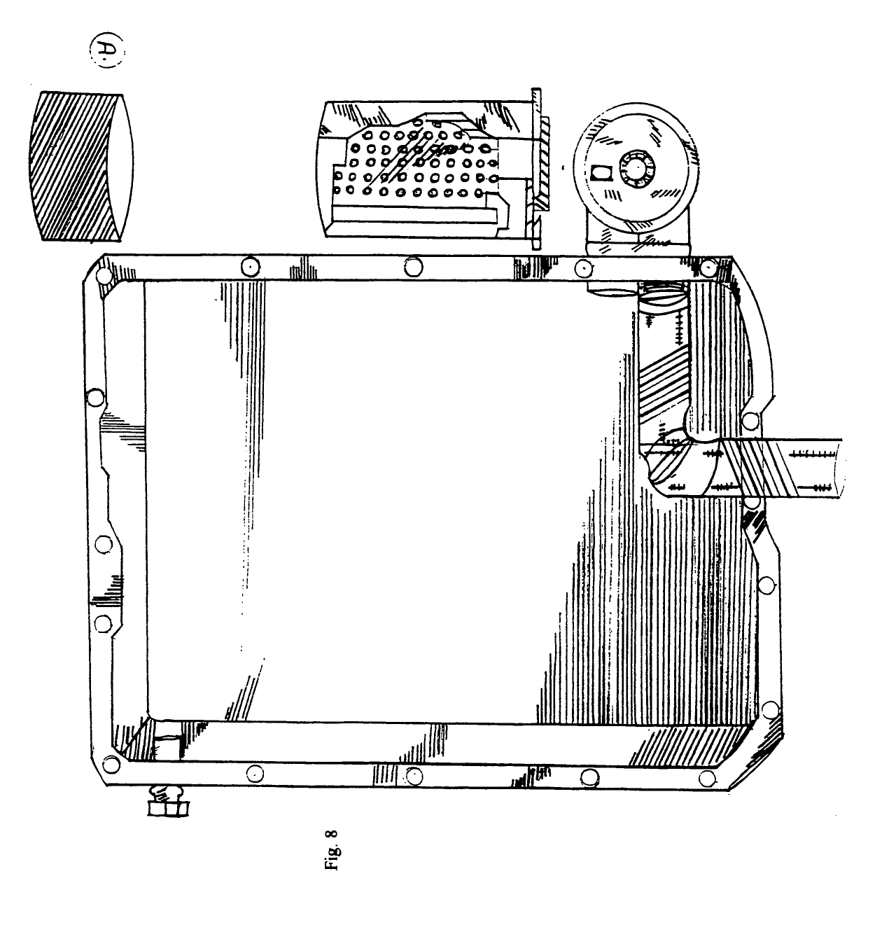

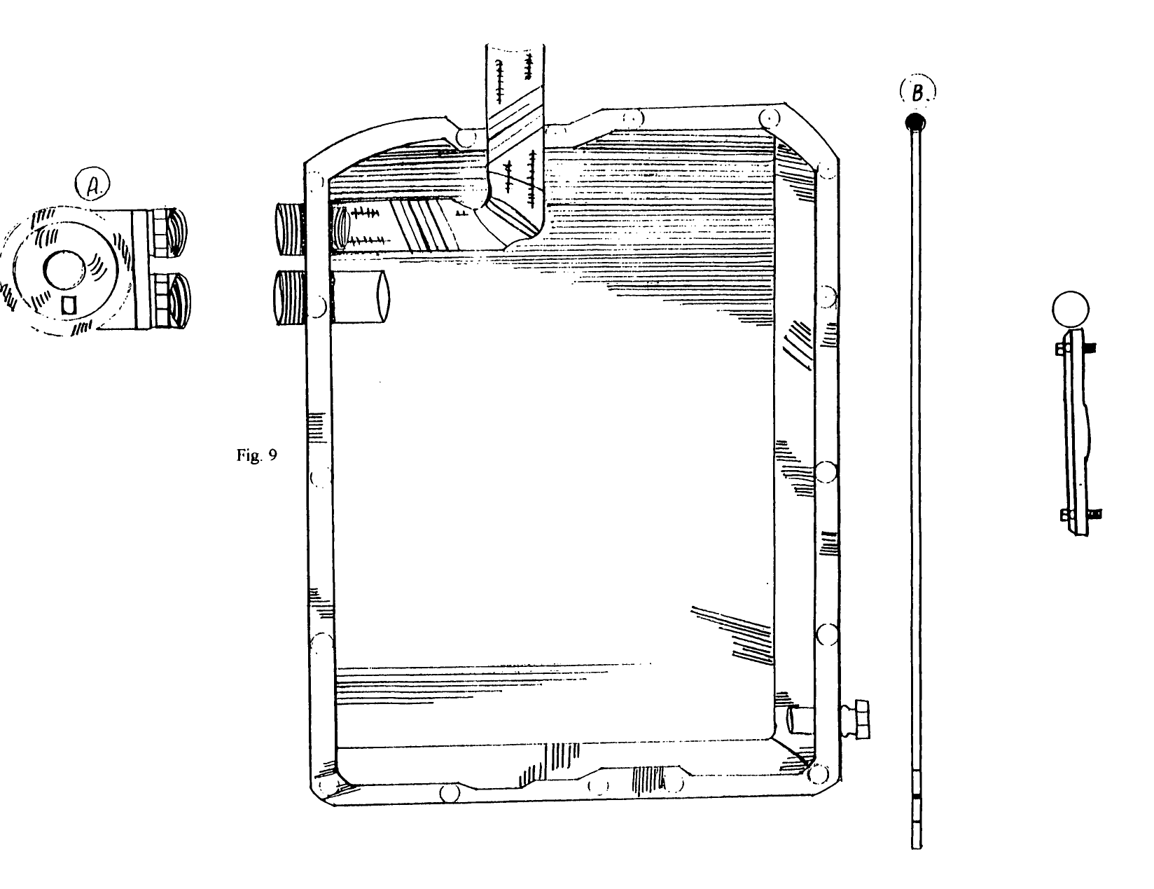

### DETAILED DESCRIPTION OF INVENTION

I am presenting a faster, easier way to change the fluid in a vehicle's transmission. With this invention the owners of the vehicle can change the transmission fluid by themselves, and professionals can do it in a third of the time. Anyone will be able to change the transmission fluid. The A.T.E.C. will allow owners to can change the fluid more often, at a reasonable price, and greatly extend the life of the transmission.

My invention uses a small plastic or aluminum tube that on one side is inserted into the transmission where the old filter was, along with the original bushing. The tube is permanently attached to the oil pan on the other end. This is now the return line for clean fluid to enter the transmission from the filter. On the outer side of the oil pan is the head of the filter. This return line has an elbow joint about half way down so when the oil pan is lifted into place, it bends to fit into the oil pan. This return line is for the cleaned fluid to be sucked up into the transmission exactly the same way as the original filter would have.

At the side of the oil pan, directly under the return line, is an opening/hole, in which the fluid is allowed to drain into the filter head then into the filter, the inlet line.

The filter is designed to let the transmission fluid filter through from the outer-sides of the filter to the center. From the center it is then sucked back up through the return line. The head of the filter is welded onto the transmission oil pan on the outside (for different vehicles it can be located on the right or left, towards the front or the back of the transmission, the return line length can be changed for different vehicles as well). The face of the head has grooves on it to allow the air to cool the fluid as it goes in, and when it comes out of the filter. This will increase the lifetime of the transmission. On the outside of the filter, around the bottom section, that is a magnetic sleeve for the filter. The magnetic sleeve can be removed and put on the new filter with every fluid change. The magnet replaces the small magnet placed by the manufacturer on inside the oil pan, so that all contaminants are trapped outside the transmission. This leaves less of a chance for debris to wear down components inside the transmission.

The drain plug can be located on any side of the transmission, wherever it is most convenient, so the oil can be drained before the filter is removed, and then sealed again when ready to fill the transmission up again with new fluid.

By placing the filter outside of the pan, the A.T.E.C. makes it possible for the fluid to be changed in a matter of minutes. All that needs to be done is drain the fluid, un-screw the old filter, screw in a new filter, and refill the transmission with fluid. The A.T.E.C. will also prolong the life of the transmission by cooling the fluid as it filters the transmission fluid. The temperature of the transmission fluid determines the lifetime of the transmission. The fluid deteriorates due to oxidation at high temperatures. With every 20-degree increase above normal (170-degrees), the life of the transmission fluid is cut in half The A.T.E.C. helps to decrease the temperature as it is constantly filtering the fluid, maintaining the viscosity of the fluid.

With the A.T.E.C. the consumer will be able to change the transmission fluid at a fraction of the price. When changing the fluid in a transmission, only about 50% of the fluid is changed due to the fact that 50% is located in the turbine. The A.T.E.C. allows the consumer change the fluid again after running the vehicle for a short time, which will remove the remaining fluid in the turbine. This will leave only approximately 10-20% of the original used “bad” fluid in the transmission, compared to 50% with a regular fluid change. The amount of debris left in the transmission will be greatly reduced and the lifespan of the transmission increased at a very reasonable low price.

What is claimed:

1. A transmission fluid pan that has the fluid filter located on the outside of the fluid pan, either on the right or left side that screws into the head which is permanently attached to the fluid pan.

2. A fluid filter head permanently attached to the outside, on either the left or right side, which has an entrance line, towards the bottom of the head, for fluid to enter the filter, and for the fluid to be filtered through the filter; then for an exit line located in the center of the filter and the filter head, and above the entrance line, where the oil is then sucked back up and into the transmission.
